(19) United States
(12) Patent Application Publication
(10) Pub. No.: US 2005/0231677 A1
(43) Pub. Date: Oct. 20, 2005

(54) Patterned electrodes for electroactive liquid-crystal ophthalmic devices

(76) Inventor: Gerald Meredith, Tucson, AZ (US)

Correspondence Address: GREENLEE WINNER AND SULLIVAN P C, 4875 PEARL EAST CIRCLE, SUITE 200, BOULDER, CO, 80301, US

(21) Appl. No.: 11/102,942

(22) Filed: Apr. 11, 2005

Related U.S. Application Data
(60) Provisional application No. 60/562,203, filed on Apr. 13, 2004.

(51) Int. Cl. G02F 1/1343

(52) U.S. Cl. 349/143

(57) ABSTRACT

Provided is an electroactive device comprising: a liquid crystal layer enclosed between a pair of transparent substrates; one or more patterned electrode sets positioned between the liquid crystal layer and the inward-facing surface of the first transparent substrate, said patterned electrode sets each comprising two or more electrodes forming an opposing pattern, said electrodes separated by an insulating layer, wherein there is no horizontal gap between the electrodes forming the patterned electrode set; and a conductive layer between the liquid crystal layer and the inward-facing surface of the second transparent substrate. The device provides greater efficiency than conventional devices.

### CROSS-REFERENCE TO RELATED APPLICATIONS

This application claims the benefit of U.S. Provisional Application Ser. No. 60/562,203, filed Apr. 13, 2004, which is hereby incorporated by reference to the extent not inconsistent with the disclosure herewith.

### BACKGROUND OF THE INVENTION

Conventional lenses used in ophthalmic devices for vision correction contain one or more fixed focusing powers. For example, people suffering from presbyopia, where the eye lens loses its elasticity and close-range focusing is compromised, use ophthalmic devices that provide different fixed powers for near and distant vision. Lenses with fixed focusing powers limit the vision correcting possibilities of lenses to standard powers and locations in the lens.

Electroactive devices, for example, electro-optically activated wavefront-control devices, such as diffractive lenses, can be used to provide different focusing powers at desired locations in the lens. U.S. Pat. Nos. 6,491,394; 6,491,391; 6,517,203; and 6,619,799 and Patent Application publication 2003/0058406 disclose an electroactive spectacle lens where an electroactive material is sandwiched between two conducting layers. Electrodes are present in a grid pattern on one of the conducting layers and different voltages are applied to different electrodes to alter the refractive index of the electroactive material. The electrodes are required to be insulated from one another.

U.S. Pat. No. 4,968,127 describes electronically adjusting the voltage passed through a liquid crystal layer between two transparent electrodes in a spectacle lens to correlate with the level of ambient light as measured by a light sensor. Because the alignment of the molecules in a liquid crystal layer increases as the electric field strength increases across electrodes, the transmission of light through the lens varies with voltage. U.S. Pat. No. 4,279,474 describes a liquid crystal-containing spectacle lens having two opposing substrates each having a transparent conductive surface. The liquid crystal layer is switched between an aligned state and a nonaligned state depending on the level of ambient light measured with a light sensor.

U.S. Pat. No. 6,341,004 describes liquid crystal displays using a stacked electrode design, where electrodes are deposited on a transparent substrate in layers, separated by layers of insulating material. WO91/10936 and U.S. Pat. No. 4,345,249 describe a liquid crystal switch element having a comb electrode pattern, where the teeth of the comb are electrically insulated from one another. U.S. Pat. No. 5,654,782 describes a device containing opposing sets of electrodes which together interact to control the orientation of a liquid crystal sandwiched between the electrodes.

Liquid crystal devices using multiple electrodes require electrical insulation between adjacent electrodes to prevent shorting. This causes the liquid crystal in the insulated area to be aligned differently than the liquid crystal in the non-insulated area, resulting in a non-optimum overall alignment of liquid crystal, and a corresponding non-desired transmission through the cell. There is a need in the art for an improved liquid crystal device.

### SUMMARY OF THE INVENTION

An electroactive device is provided comprising: a liquid crystal layer between a pair of opposing transparent substrates; one or more patterned electrode sets positioned between the liquid crystal layer and the inward-facing surface of the first transparent substrate, said patterned electrode sets each comprising two or more electrodes forming an opposing pattern, said electrodes separated by an insulating layer, wherein there is no horizontal gap between the electrodes forming the patterned electrode set; and a conductive layer between the liquid crystal layer and the inward-facing surface of the second transparent substrate.

More than one patterned electrode set can be positioned on the first transparent substrate in a non-overlapping manner in the device. For example, two patterned electrode sets, each having an overall half-circle shape (or any other shape) can be positioned side-by-side on the inward-facing surface of the first transparent substrate to allow for switching quickly between two distances (paper and a computer screen, for example). The patterned electrode set(s) can occupy any desired amount of the area of the first transparent substrate. For example, the patterned electrode set can occupy the top or bottom half of the first transparent substrate, as in conventional multi-focal lenses. The patterned electrode set can occupy the left or right half of the first transparent substrate. The patterned electrode set can occupy the entire area or a portion in the middle of the first transparent substrate. Electrode sets occupying varying amounts of the area of the first transparent substrate and all locations in that area are intended to be included in the invention.

Also provided are methods of diffracting light, comprising applying one or more different voltages to the electrodes of the electroactive device described herein. This causes the liquid crystal to reorient and provide the desired phase transmission function. Various methods of applying voltage to the electrodes can be used, as known in the art. A battery can be used to supply the voltage, or other methods, as known in the art. It is known in the art that various methods of controlling all aspects of the voltage applied to electrodes can be used, including a processor, a microprocessor, an integrated circuit, and a computer chip. The voltage applied is determined by the desired phase transmission function, as known in the art.

Also provided is a patterned electrode comprising: a substrate; one or more areas of conductive material arranged in a pattern on said substrate; one or more areas of insulating material arranged in a complementary pattern with said areas of conductive material on said substrate. The conductive material may be any suitable material, including those specifically described herein, and other materials known in the art. The insulating material may be any suitable material, including those specifically described herein, and other materials known in the art. The conductive material and insulating material are arranged in alternating patterns, for example circles with increasing radius (see FIG. 1, which shows two patterned electrodes, for example). The patterns may be any desired pattern, such as circular, semi-circular, square, angular, or any other shape that provides the desired effect, as described herein. The terms “circular, semi-circular, square, angular” and other shapes are not intended to mean a perfect shape is formed, rather, the shape is generally formed, and may include, as known in the art, bus lines or other methods of bringing current through the substrate.

Also provided is a patterned electrode set comprising two or more electrodes forming an opposing pattern, said electrodes separated by an insulating layer, wherein there is no horizontal gap between the electrodes forming the patterned electrode set.

As used herein, “horizontal” means perpendicular to the substrate direction. As used herein, “no horizontal gap” between electrodes includes the situation where the electrodes have no space when viewed in the horizontal direction and also includes the situation where there is a space between electrodes when viewed in the horizontal direction that does not cause the diffraction efficiency of the optic to be reduced by more than 25% from the theoretical maximum, as well as all individual values and ranges therein. As used herein, “layer” does not require a perfectly uniform film. Some uneven thicknesses, cracks or other imperfections may be present, as long as the layer performs its intended purpose, as described herein.

The devices of the invention can be used in a variety of applications known in the art, including lenses used for human or animal vision correction or modification. The lenses can be incorporated in spectacles, as known in the art. Spectacles can include one lens or more than one lens. The devices may also be used in display applications, as known to one of ordinary skill in the art without undue experimentation. The lenses of the invention can be used with conventional lenses and optics. The lenses of the invention can be used as a portion of a conventional lens, for example as an insert in a conventional lens, or a combination of conventional lenses and lenses of the invention can be used in a stacked manner.

### BRIEF DESCRIPTION OF THE FIGURES

FIG. 1 shows one embodiment of two electrodes that form a patterned electrode set.

FIG. 2 shows four diffractive lens phase transmission functions.

FIG. 3 shows a device having four zones, each zone having four electrodes.

FIG. 4 shows a schematic of a liquid crystal cell incorporating a patterned electrode set.

FIG. 5 shows one example of the fabrication process.

FIG. 6 shows a cell using glass spacers.

FIG. 7 shows phase-sensitive microscopic images of 4-step diffractive lenses.

FIG. 8 shows imaging in a model eye.

FIG. 9 shows a phase map of the electro-optically-induced focusing-wave from a 2-diopter, 4-step diffractive lens. The shading indicates the optical path difference.

### DETAILED DESCRIPTION OF THE INVENTION

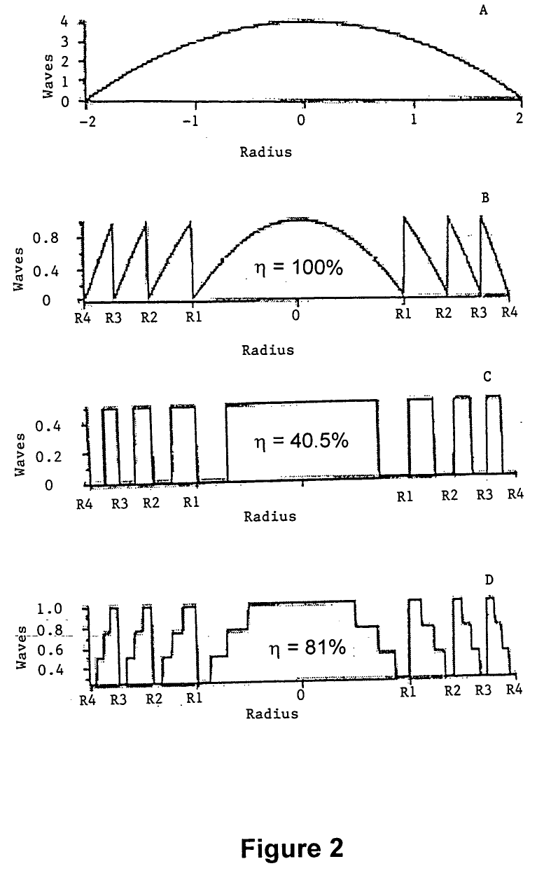

Diffractive lenses are known in the art. FIG. 2 shows four diffractive lens phase transition functions. The perfect spherical-focusing phase profile is shown in FIG. 2A. FIG. 2B shows a diffractive lens with a continuous quadratic blaze profile. FIG. 2C shows a phase-reversal (or Wood) lens. FIG. 2D shows a four-level approximation to the quadratic blaze profile. As shown in FIG. 2C, the efficiency of the phase-reversal lens is 40.5%. The efficiency of the four-level (four-step) approximation in FIG. 2D is 81%. A four-level approximation was chosen in the experiments described herein to approximate the quadratic blaze profile, although a higher-level approximation can be used, and would result in higher efficiency and smaller electrode zones, as known in the art.

This invention provides electroactive lenses filled with liquid crystal material that can be realigned in an electric field. The lenses function as diffractive-optical-elements (DOE). DOE are the result of applying voltages across a thin liquid-crystal layer which responds by altering the director-orientation field and creates nonuniform refractive-index patterns which then lead to a nonuniform phase-transmission-function (PTF) across the face of the cell. Accurate control of the PTF to create the desired DOE is achieved by applying an accurately controlled voltage pattern across the cell by the use of one or more patterned electrode sets. The electrodes are preferably patterned from conductive, transparent films, but other materials may be used, as known to one of ordinary skill in the art. Photolithographic processes known to one of ordinary skill in the art, including etching, are used to create the desired electrode pattern.

Electrodes positioned on a single smooth surface must have gaps between them to prevent electrical shorting or breakdown. Without resorting to very high resolution photolithography, gaps of at least a few microns must be used. When different voltages are applied to adjacent electrodes on the same surface, electric field lines in the gaps will then not be dominantly longitudinal, in fact they will be transverse at the first substrate's inner surface and become more longitudinal closer to the second substrate's conductive surface (e.g. at an unpatterned ground). The result is that the liquid crystal in the vicinity of a gap is not oriented consistently with the pattern required to achieve the desired PTF. In fact, in these gaps the retardation often is not changed observably from the cell's overall unactivated value. The functioning of a DOE is the result of coherent superposition of light (i.e. both constructive and destructive interference). When light passes through these gaps and is given incorrect increments of phase, the result can be degradation of performance out-of-proportion to the area of these gaps relative to the area of the entire DOE cell. Therefore, though one may reduce the area of the gaps to a level of 10-15% the consequence may be a reduction in the efficiency of the desired diffraction order by much more than this. For example, in a 10 mm DOE spherical lens with 10 micron gaps between electrodes, the efficiency of diffraction into the first order is reduced by about 50% from the perfect-lens predictions, a result consistent with modeling of the phenomenon.

The situation is made worse for DOE spherical lenses larger than 10 mm in diameter because in a simple stepped-phase diffractive lens the radial location of the steps (Rₘ) varies as the square-root of the step number (m):
Rₘ=[2fλm/q]^{1/2}
where f is the focal length, q is the number of steps per Fresnel zone in the desired phase transmission function, and λ is the wavelength so that the m^{th} step number electrode's width (Wₘ) is
Wₘ=Rₘ−R₍ₘ₋1)
≈Rₘ/2m, for m>4

For a 1 diopter (f=1 meter), 4-phase-step (q=4), diffractive lens designed for the 555 nm photopic response maximum wavelength (λ=0.555×10⁻⁶ meter), the table below illustrates the situation.

| Step Number | | |
|---|---|---|
| in Fresnel Zone | Radial Location (mm) | Width of Phase Feature (um) |
| 1 | 0.527 | 527 |
| 10 | 1.666 | 85 |
| 25 | 2.634 | 53 |
| 100 | 5.268 | 26 |
| 200 | 7.450 | 19 |

A ten micron gap would become significant (occupying about 10% of the local surface area) at the periphery of a 3 mm diameter lens and dominant (occupying more than 50% of the local surface area) in a 15 mm lens—a size range required for spectacle lens applications.

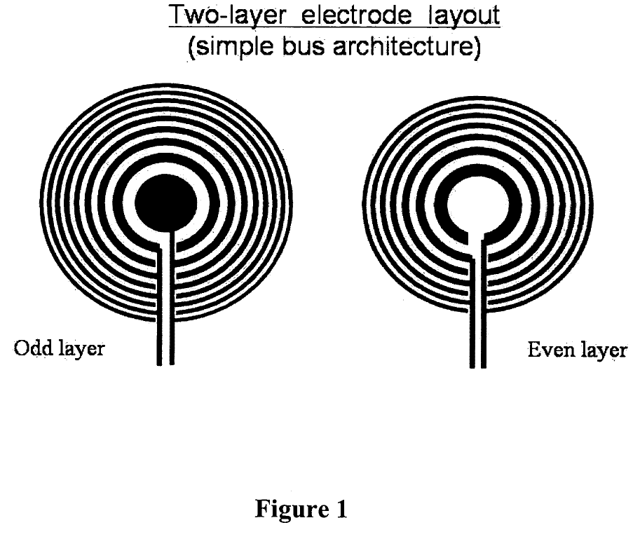

The present invention locates adjacent electrodes on different surfaces instead of the same surface. In this way electrodes can be made larger (e.g. fully occupying the area assigned to a specific phase-feature in the desired PTF, or even larger if not the uppermost electrode and thus reduce or fully eliminate gaps in the optical transmission field of the cell/device; required electrical gaps are provided by insulating thin films (or using terraced steps in a substrate which are subsequently filled to planarize the surface), and the overall electrical field of the working cell is basically longitudinal, with the incorrect fringing fields—from the point of view of the liquid crystal performance—being localized to the extent possible in and near the insulator film at the phase-steps. Since each electrode in the lens is highly conductive, the electrode establishes a (nearly) equipotential structure. Even if the electrode is positioned so that it overlays with another electrode which is larger than required to fill its designed space, the electrode will still establish the desired potential (at a cost of perturbed charge distribution to overcome the effect of the other larger electrode). The potential pattern seen inside the cell will be dominated by the potential on the “observable” electrode pieces (such as the pattern shown in FIG. 1). Voltages applied to the electrodes are only a few volts. Various thin dielectric films (e.g. SiO₂ or polymers such as polyimides) can adequately insulate conductors at these low voltage levels. It is necessary that the insulating films be transparent, and that electrodes can be deposited and patterned on them.

Conventional Electrode Gap Device

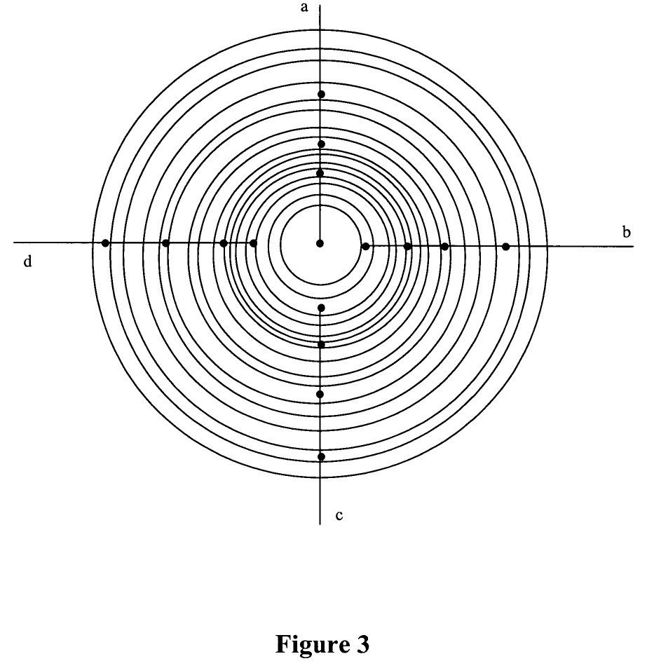

To model the four-level approximation shown in FIG. 2D, a device was prepared with four zones having gaps between electrodes. FIG. 3 shows the electrode layout in a device having four zones, each zone having four electrodes. The lines indicate the bus lines. The vias are represented by the dots. Each bus connects one electrode per zone. A via layer mask was placed on a substrate having an ITO patterned zone. A layer of SiO₂ was deposited on the ITO, followed by a layer of photoresist. UV light activated the photoresist. The photoresist that was not masked was removed to form the via. A conductive material (Ag in this example) was applied to form the via. Electrodes were formed using an analogous masking.

The algorithm used to generate electrodes and electrode boundaries is:
ⁱₙ=[{4(n−1)+i}λₒfₒ/2]^{1/2}
where n=1, 2, 3, 4 . . . and is the zone index
i=0, 1, 2, 3, 4 and are the points where the ideal electrode boundaries occur in a given zone
i=0 corresponds to the inner zone radius and i=4 corresponds to the outer zone radius
λₒ is the design wavelength
fₒ is the primary focal length.

In this example, a device having two 1 Diopter lenses with electrode spacings of 5 μm and 10 μm each, a 2 Diopter lens with electrode spacing of 5 mm and one 2 Diopter hybrid lens with electrode spacing of 10 μm was made. The via size and the bus bar width was 10 μm. Quartz was used as the substrate. This lens was measured to have a diffraction efficiency of 70%.

No Gap Device

To eliminate or reduce the effect of electrode gaps, the present invention provides devices comprising one or more electrode sets with no horizontal gaps.

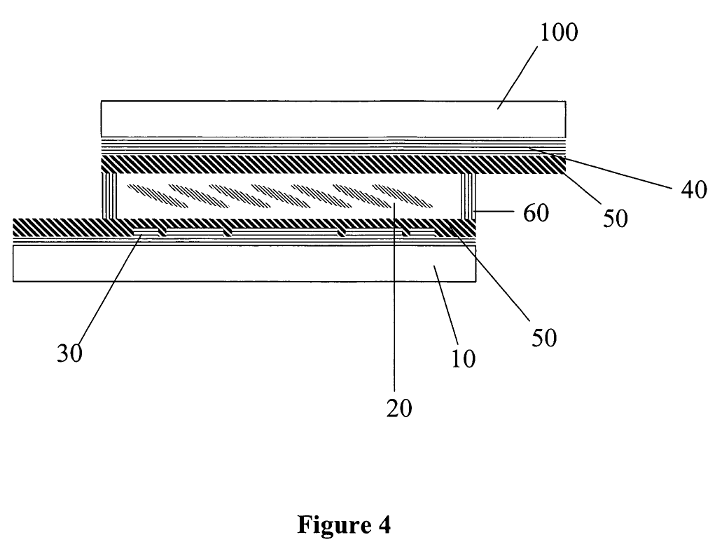

A schematic diagram illustrating how the patterned electrodes are incorporated in a liquid crystal cell is shown in FIG. 4. Transparent substrates 10 and 100 are positioned with inward-facing surfaces surrounding a liquid crystal layer 20. A patterned electrode set 30 is formed on the inward-facing surface of first transparent substrate 10. A conductive layer 40 is formed on the inward-facing surface of second transparent substrate 100. Alignment layers 50 are formed surrounding liquid crystal layer 20. The transparent substrates can be spaced using a variety of methods, as known in the art, including glass spacers 60.

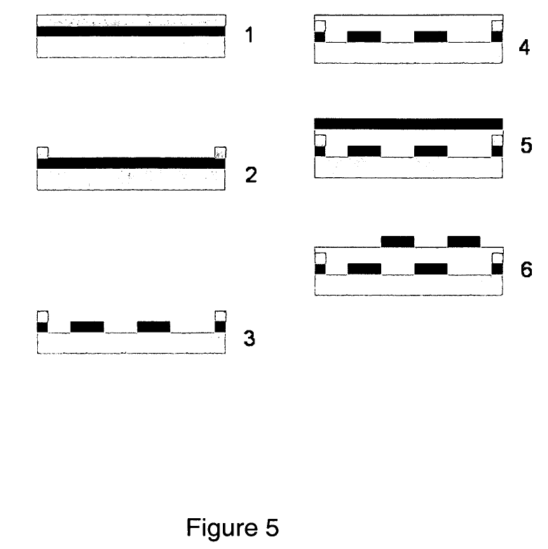

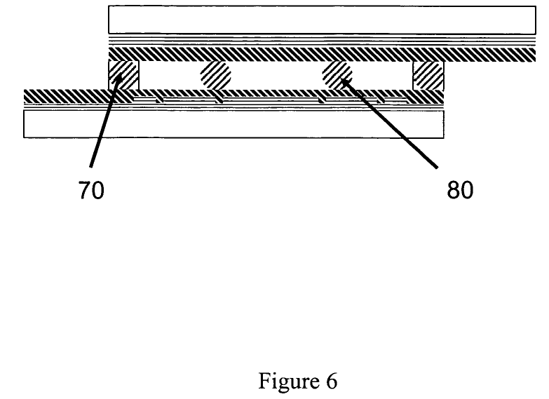

One non-limiting example of the construction of electroactive lens of the invention follows and is shown in FIG. 5. A layer of a transparent conductor is deposited on the inner surface of both transparent substrates. The transparent conductor can be any suitable material, such as indium oxide, tin oxide or indium tin oxide (ITO). Glass, quartz or plastic may be used for the substrate, as known in the art. A conducting layer (in this example, Cr), is deposited onto the transparent conductor (shown in step 1). The thickness of the conducting layer is typically between 30 nm and 200 nm. The layer must be thick enough to provide adequate conduction, but no so thick as to provide excess thickness to the overall lens structure. For substrates onto which patterned electrodes will be applied, alignment marks are patterned on the conducting layer. Patterning the alignment marks is shown in step 2. Any suitable material may be used for the alignment marks, such as Cr. The alignment marks allow proper alignment of the various photolithographic masks to the substrate and therefore of the patterns which are created in the processing steps associated with use of each mask from the “mask set” that was made in order to have the desired total photolithographic definition of the electrodes when the electrodes are patterned. One group of patterned electrodes is formed in the conducting layer using methods known in the art and described herein (shown in step 3). A layer of insulator, such as SiO₂ is deposited onto the patterned conductor layer (shown in step 4). A second layer of conductor is deposited onto the SiO₂ (shown in step 5) and the second group of patterned electrodes is formed in the second layer of conductor (shown in step 6). The first and second groups of patterned electrodes form a patterned electrode set. An alignment layer is placed on the second layer of conductor and over the second substrate's conductor. The alignment layer is prepared by means known in the art such as unidirectional rubbing. Currently used alignment layers are spin coated polyvinyl alcohol or nylon 6,6. It is preferred that the alignment layer on one substrate is rubbed antiparallel from the alignment layer on the other substrate. This allows proper alignment of the liquid crystal, as known in the art. A layer of liquid crystal is placed between the substrates, and the substrates are kept at a desired distance apart with glass spacers (shown in FIG. 6), or other means known in the art. In order to achieve efficient diffraction the liquid crystal layer must be thick enough to provide one wave of activated retardation (d>λ/δn˜2.5 μm, where δn is the birefringence of the liquid crystal media), but thicker liquid crystal layers help to avoid saturation phenomena. Disadvantages of thicker cells include long switching times (varying as d²) and loss of electroactive feature definition. The transparent substrates can be spaced any distance apart that allows for the desired number of patterned electrode sets and the desired thickness of liquid crystal layer. Preferably, the transparent substrates are spaced between three and 20 microns apart, and all individual values and ranges therein. One currently preferred spacing is 5 microns.

In operation, the voltage required to change the index of refraction to a desired level is applied to the electrodes by a controller. A “controller” can include or be included in a processor, a microprocessor, an integrated circuit, an IC, a computer chip, and/or a chip. Typically, voltages up to about 2 Vrms are applied to the electrodes. Phase-synchronized, waveform controlling drivers are connected to each electrode group in common-ground configuration. Driver amplitudes are simultaneously optimized for maximum focusing diffraction efficiency. The voltage function required to change the index of refraction to a desired level is determined by the liquid crystal or liquid crystal mixture used, as known in the art.

FIG. 6 describes the assembly of one example of a cell using the description of the invention. The cell is assembled empty with 5 micron diameter fiber spacers set in a UV curable adhesive at the four corners of the cell (70) as well as dispersed loose throughout the cell (80) to maintain spacing. The cell is filled with liquid crystal above the clearing temperature by capillary action. The cell is held at temperature for some time (about ½ hour) and then cooled slowly to room temperature.

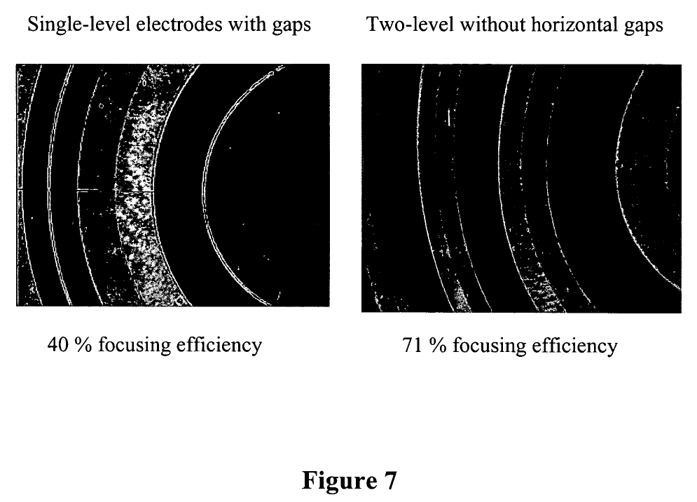

FIG. 7 shows phase-sensitive microscopic images of 4-step diffractive lenses. The left hand image shows a lens having a electrodes deposited on a single substrate, with gaps between the electrodes. This lens has a 40% focusing efficiency. The right hand image shows a lens of the invention having a patterned electrode set of the present invention without horizontal gaps, showing a 71% focusing efficiency.

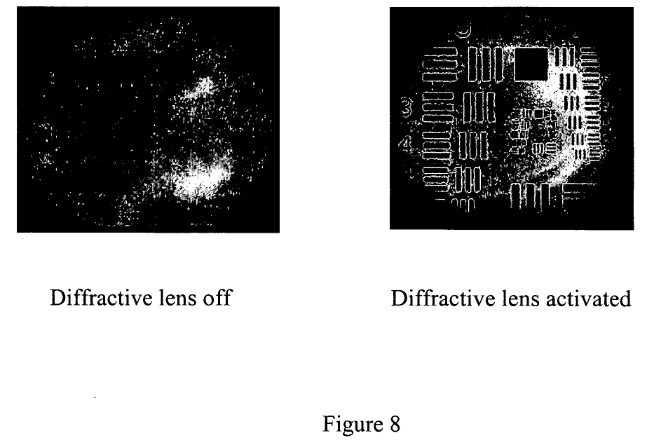

FIG. 8 shows a simulation of reading in a presbyopic human eye at 30 cm using a 2-diopter, 4-step diffractive lens of the present invention. The left hand image shows the diffractive lens off. The right hand image shows the diffractive lens activated.

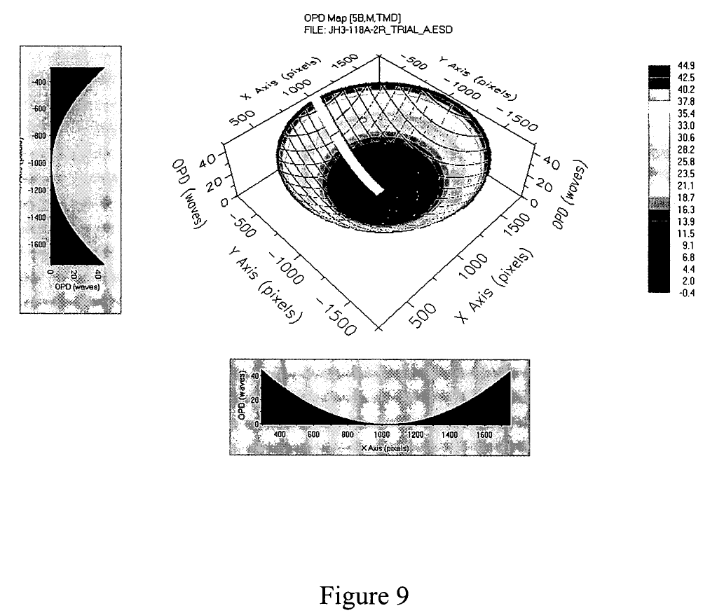

FIG. 9 shows the interferometrically determined phase map of the electro-optically-induced focusing-wave from a 2-diopter, 4-step diffractive lens of the present invention. The global RMS value is 0.89 wave in a no horizontal gap electrode lens, but more than three times greater in a gap-containing lens.

As described further herein, preferably the electrodes forming the patterned electrode set form a circular pattern, however, any pattern that provides the desired phase transmission function is included in the invention. For example, circular patterns produce spherical lenses. Elliptical patterns can provide cylindrical correction for astigmatism. More complex patterns, such as a grid in which individual-specific phase correction patterns are defined on a pixilated basis and activated, can provide more complex wavefront correction associated with general ocular refractive error or to produce “super vision” (i.e., better than 20/20). Other patterns are useful to customize the visual field, as for example split (semicircular) patterns to allow simultaneous (add-power) corrections to near and intermediate vision for spatially segregated work (e.g. shifting rapidly between a paper and a computer screen). More complex patterns are useful with more complex sensing and driving capabilities—for instance a (honeycomb) hexagonal array of pixels provides movable (e.g. eyetracking) lenses and greater flexibility and precision in vision correction. When more complex patterns are required, as many layers of patterned electrodes will be needed as there are unique electrodes intersecting at any boundary apex—for instance there will be three layers required for the hexagonal array or its topological equivalent, a staggered brickwork array.

The liquid crystal used in the invention include those that form nematic, smectic, or cholesteric phases that possess a long-range orientational order that can be controlled with an electric field. It is preferred that the liquid crystal have a wide nematic temperature range, easy alignability, low threshold voltage, large electroactive response and fast switching speeds, as well as proven stability and reliable commercial availability. In one preferred embodiment, E7 (a nematic liquid crystal mixture of cyanobiphenyls and cyanoterphenyls sold by Merck) is used. Examples of other nematic liquid crystals that can be used in the invention are: pentyl-cyanobiphenyl (5CB), (n-octyloxy)-4-cyanobiphenyl (80CB). Other examples of liquid crystals that can be used in the invention are the n=3, 4, 5, 6, 7, 8, 9, of the compounds 4-cyano-4-n-alkylbiphenyls, 4-n-pentyloxy-biphenyl, 4-cyano-4″-n-alkyl-p-terphenyls, and commercial mixtures such as E36, E46, and the ZLI-series made by BDH (British Drug House)-Merck.

Electroactive polymers can also be used in the invention. Electroactive polymers include any transparent optical polymeric material such as those disclosed in “Physical Properties of Polymers Handbook” by J. E. Mark, American Institute of Physics, Woodburry, N.Y., 1996, containing molecules having unsymmetrical polarized conjugated p electrons between a donor and an acceptor group (referred to as a chromophore) such as those disclosed in “Organic Nonlinear Optical Materials” by Ch. Bosshard et al., Gordon and Breach Publishers, Amsterdam, 1995. Examples of polymers are as follows: polystyrene, polycarbonate, polymethylmethacrylate, polyvinylcarbazole, polyimide, polysilane. Examples of chromophores are: paranitroaniline (PNA), disperse red 1 (DR 1), 3-methyl-4-methoxy-4′-nitrostilbene, diethylaminonitrostilbene (DANS), diethyl-thio-barbituric acid. Electroactive polymers can be produced by: a) following a guest/host approach, b) by covalent incorporation of the chromophore into the polymer (pendant and main-chain), and/or c) by lattice hardening approaches such as cross-linking, as known in the art.

Polymer liquid crystals (PLCs) may also be used in the invention. Polymer liquid crystals are also sometimes referred to as liquid crystalline polymers, low molecular mass liquid crystals, self-reinforcing polymers, in situ-composites, and/or molecular composites. PLCs are copolymers that contain simultaneously relatively rigid and flexible sequences such as those disclosed in “Liquid Crystalline Polymers: From Structures to Applications” by W. Brostow; edited by A. A. Collyer, Elsevier, New-York-London, 1992, Chapter 1. Examples of PLCs are: polymethacrylate comprising 4-cyanophenyl benzoate side group and other similar compounds.

Polymer dispersed liquid crystals (PDLCS) may also be used in the invention. PDLCs consist of dispersions of liquid crystal droplets in a polymer matrix. These materials can be made in several ways: (i) by nematic curvilinear aligned phases (NCAP), by thermally induced phase separation (TIPS), solvent-induced phase separation (SIPS), and polymerization-induced phase separation (PIPS), as known in the art. Examples of PDLCs are: mixtures of liquid crystal E7 (BDH-Merck) and NOA65 (Norland products, Inc. NJ); mixtures of E44 (BDH-Merck) and polymethylmethacrylate (PMMA); mixtures of E49 (BDH-Merck) and PMMA; mixture of the monomer dipentaerythrol hydroxy penta acrylate, liquid crystal E7, N-vinylpyrrolidone, N-phenylglycine, and the dye Rose Bengal.

Polymer-stabilized liquid crystals (PSLCs) can also be used in the invention. PSLCs are materials that consist of a liquid crystal in a polymer network in which the polymer constitutes less than 10% by weight of the liquid crystal. A photopolymerizable monomer is mixed together with a liquid crystal and an UV polymerization initiator. After the liquid crystal is aligned, the polymerization of the monomer is initiated typically by UV exposure and the resulting polymer creates a network that stabilizes the liquid crystal. For examples of PSLCs, see, for instance: C. M. Hudson et al. Optical Studies of Anisotropic Networks in Polymer-Stabilized Liquid Crystals, Journal of the Society for Information Display, vol. 5/3, 1-5, (1997), G. P. Wiederrecht et al, Photorefractivity in Polymer-Stabilized Nematic Liquid Crystals, J. of Am. Chem. Soc., 120, 3231-3236 (1998).

Self-assembled nonlinear supramolecular structures may also be used in the invention. Self-assembled nonlinear supramolecular structures include electroactive asymmetric organic films, which can be fabricated using the following approaches: Langmuir-Blodgett films, alternating polyelectrolyte deposition (polyanion/polycation) from aqueous solutions, molecular beam epitaxy methods, sequential synthesis by covalent coupling reactions (for example: organotrichlorosilane-based self-assembled multilayer deposition). These techniques usually lead to thin films having a thickness of less than about 1 μm.

This invention is useful in preparing spectacles having lenses that adjust focusing strength based on distance from the object viewed. In one embodiment, a range-finding mechanism, battery and control circuitry are housed in the spectacles or are part of a separate control system. These components and their use are known in the art. As one example, the range-finding mechanism is used to determine the distance between the spectacle and a desired object. This information is fed to a microprocessor which adjusts the voltage applied to the patterned electrode set, which gives the lens the desired phase transmission function to view the object.

The invention is not limited in use to spectacles. Rather, as known by one of ordinary skill in the art, the invention is useful in other fields such as telecommunications, optical switches and medical devices. Any liquid crystal or mixture of liquid crystals that provides the desired phase transmission function at the desired wavelength is useful in the invention, as known by one of ordinary skill in the art. Determining the proper voltage and applying the proper voltage to liquid crystal materials to produce a desired phase transmission function is known in the art.

One of ordinary skill in the art will appreciate that methods, device elements, starting materials, and fabrication methods other than those specifically exemplified can be employed in the practice of the invention without resort to undue experimentation. All art-known functional equivalents, of any such methods, device elements, starting materials, and fabrication methods are intended to be included in this invention. Whenever a range is given in the specification, for example, a temperature range, a time range, or a thickness range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions provided are intended to clarify their specific use in the context of the invention. All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The devices and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

1. An electroactive device comprising:
a liquid crystal layer enclosed between a pair of transparent substrates;
one or more patterned electrode sets positioned between the liquid crystal layer and the inward-facing surface of the first transparent substrate, said patterned electrode sets each comprising two or more electrodes forming an opposing pattern, said electrodes separated by an insulating layer, wherein there is no horizontal gap between the electrodes forming the patterned electrode set; and
a conductive layer between the liquid crystal layer and the inward-facing surface of the second transparent substrate.

2. The device of claim 1, wherein a patterned electrode set forms a circular pattern.

3. The device of claim 1, wherein a patterned electrode set forms an elliptical pattern.

4. The device of claim 1, comprising two non-overlapping patterned electrode sets.

5. The device of claim 1, wherein the liquid crystal is E7.

6. The device of claim 1, wherein the transparent substrates are glass.

7. The device of claim 1, wherein the transparent substrates are plastic.

8. The device of claim 1, further comprising an electrical control electrically connected to the patterned electrode sets and the conductive layer.

9. The device of claim 8, further comprising a range-finding device electrically connected to the electrical control.

10. The device of claim 1, wherein the electrodes and conductive layer are indium-tin-oxide.

11. The device of claim 1, further comprising an alignment layer surrounding the liquid crystal layer.

12. The device of claim 11, wherein the alignment layer is polyvinyl alcohol.

13. The device of claim 11, wherein the alignment layer is nylon 6,6.

14. The device of claim 1, wherein the transparent substrates are between about 3 and about 20 microns apart.

15. The device of claim 14, wherein the transparent substrates are between about 3 and about 8 microns apart.

16. A method of diffracting light comprising:
applying a voltage to the device of claim 1, whereby the phase of light transmitted through the transparent substrates is altered.

17. The method of claim 16, wherein the voltage applied is less than or equal to 2 Vrms.

18. A method of adjusting the diffraction in a device comprising a liquid crystal layer enclosed between a pair of transparent substrates; one or more patterned electrode sets positioned between the liquid crystal layer and the inward-facing surface of the first transparent substrate, said patterned electrode sets each comprising two or more electrodes forming an opposing pattern, said electrodes separated by an insulating layer, wherein there is no horizontal gap between the electrodes forming the patterned electrode set; a conductive layer between the liquid crystal layer and the inward-facing surface of the second transparent substrate; and an electrical control electrically connected to the patterned electrode sets and the conductive layer;
said method comprising:
determining the desired amount of diffraction;
applying a voltage to the patterned electrode set and conductive layer so that the device has the desired amount of diffraction.

19. The method of claim 18, wherein the desired amount of diffraction is determined using a range-finding device to determine the distance between the device and a desired object and correlating the distance with the voltage applied.

20. A patterned electrode comprising:
a substrate;
one or more areas of conductive material arranged in a pattern on said substrate;
one or more areas of insulating material arranged in a complementary pattern with said areas of conductive material on said substrate.

21. The patterned electrode of claim 20, wherein the pattern is circular.

22. The patterned electrode of claim 20, wherein the pattern is angular.

23. The patterned electrode of claim 20, wherein the pattern is semicircular.

24. A patterned electrode set comprising two or more electrodes forming an opposing pattern, said electrodes separated by an insulating layer, wherein there is no horizontal gap between the electrodes forming the patterned electrode set.

25. The patterned electrode set of claim 24, wherein the two or more electrodes are the electrodes of claim 20.
